(19) United States
(12) Patent Application Publication
(10) Pub. No.: US 2026/0031373 A1
(43) Pub. Date: Jan. 29, 2026

(54) PURIFYING METHOD FOR AN ELECTROLYTE LIQUID OF A REDOX FLOW BATTERY

(71) Applicant: Enerox GmbH, Wiener Neudorf (AT)

(72) Inventors: Pavel Mardilovich, Wien (AT); Peter Pokorny, Mauerbach (AT)

(21) Appl. No.: 18/720,438

(22) PCT Filed: Dec. 13, 2022
(86) PCT No.: PCT/EP2022/085494

§ 371 Date: Jun. 14, 2024

(30) Foreign Application Priority Data
Dec. 15, 2021 (AT) A51006/2021

(51) Int. Cl. H01M 8/04276; H01M 8/18; H01M 8/24

(52) U.S. Cl. CPC H01M 8/04276; H01M 8/188; H01M 8/24

(57) ABSTRACT

In order to efficiently reduce the concentration of contaminants in an electrolyte liquid suitable for a redox flow battery, the electrolyte liquid, after passing through the negative half-cells of the one or more cell stacks, passes through positive half-cells of the one or more cell stacks of the purifying redox flow battery, without passing through a second tank, via a connecting device that connects the negative half-cells and the positive half-cells of a cell stack to one another.

The present invention describes a method for reducing contaminants in an electrolyte liquid suitable for a redox flow battery.

A redox flow battery is a system for energy generation and storage on electrochemical basis, typically consisting of tanks for storing positive and negative electrolyte fluids, and pumps and conduits for circulating the electrolyte fluids through one or more cell stacks, each of which is comprised of a number of cells. The cells of the cell stack are each formed by a positive half-cell and a negative half-cell, with the positive and negative half-cells of a cell separated by a semipermeable membrane, typically an ion exchange membrane. The positive half-cell contains a positive electrode mounted in a frame through which the positive electrolyte fluid flows. The negative half-cell contains a negative electrode mounted in a frame through which the negative electrolyte fluid flows. In a vanadium redox flow battery, the positive electrolyte liquid in the charged state consists of vanadium having an oxidation number of +4 (also referred to as V^{IV}) and vanadium having an oxidation number of +5 (also referred to as V^{V}). In the charged state, the negative electrolyte liquid consists of vanadium having an oxidation number of +2 (also referred to as V^{II}) and of vanadium having an oxidation number of +3 (also referred to as V^{III}), making the negative electrolyte liquid “more negative” than the positive electrolyte liquid. The average oxidation number of the total electrolyte liquid (negative and positive considered as a whole) is therefore +3.5. Both, the positive and the negative electrolyte liquid can furthermore contain sulfuric acid and other additives. The positive and negative electrodes are usually made as porous mats made of graphite which can be made to flow through by the electrolyte fluid. Bipolar electrode plates, which are usually made from a composite material of carbon and plastic, are arranged between individual adjacent cells in the cell stack. On the axially outer sides of the axially outside cells of the cell stack, there are current collectors on the electrode plates, via which an electrical contact is routed to the outside in order to be able to tap off electrical voltage (discharging the redox flow battery) or to be able to apply an electrical voltage (charging the redox flow battery). The cell stack is terminated on the outer axial sides by a negative end plate and a positive end plate in each case, which hold the cell stack together.

The vanadium used in a vanadium electrolyte liquid is usually found in chemical compounds with other elements. During production of vanadium electrolyte liquids, it is important that contaminants affecting the performance of the vanadium redox battery are kept to a minimum. In particular, contaminants from hydrogen catalysts such as copper (Cu), silver (Ag), gold (Au), arsenic (As), antimony (Sb) and elements of the platinum group should be reduced as much as possible in the electrolyte liquid, since excessive hydrogen development during operation can significantly reduce the efficiency of the vanadium redox battery. It is therefore advantageous to remove contaminants from an electrolyte liquid before it is used to store energy in a redox flow battery.

The starting material for the vanadium electrolyte liquid is usually V^{V}, e.g., vanadium pentoxide (V₂O₅) or ammonium metavanadate (NH₄VO₃). However, as these materials are extracted in mines, the quality, i.e., the degree of contamination of the starting material, can vary greatly. The starting material is often chemically purified before being treated any further in order to achieve an initial reduction in contaminants, as disclosed in EP 0713257 A1, for example. This purification is usually carried out by adjusting various parameters such as the pH value and temperature. This method is used to selectively separate sulphates, hydroxides or oxides, whereupon the pre-purified starting material is dissolved in sulfuric acid (H₂SO₄). The solution is then reduced, wherein a chemical reduction using hydrogen (H₂), carbon monoxide (CO), sulfur dioxide (SO₂), etc. can occur. As part of this reduction, a mixture of V^{III} and V^{IV} is produced in equal proportions, as disclosed in CN 102354762 A, for example. Starting from this mixture of V^{III} and V^{IV}, negative electrolyte liquid (containing V^{II} and V^{III}) can be produced by further chemical reduction, or positive electrolyte liquid (containing V^{IV} and V^{V}) can be produced by chemical oxidation. Prior to this, as disclosed in EP 1406333 A1, the pre-purified electrolyte liquid can also be filtered to remove particles. EP 2576719 A1, for example, shows a filter series containing chelate resin. By using the aforementioned filter methods, elements of the platinum group (ruthenium Ru, rhodium Rh, palladium Pd, osmium Os, iridium Ir and platinum Pt) can be reduced to a proportion of less than 4.5 ppm by weight in the electrolyte liquid, for example. Since even lower concentrations of contaminants are advantageous in order to additionally reduce parasitic hydrogen development occurring due to these contaminants during operation of a redox flow battery, the method according to AT 519236 A4 was developed, which allows for reducing the critical, usually metallic contaminants in the electrolyte liquid to a concentration of less than 1 ppm by weight.

It is therefore an object of the present invention to provide a method by which the concentration of contaminants in an electrolyte liquid suitable for a redox flow battery can be efficiently reduced.

A purifying method for reducing contaminants in an electrolyte liquid suitable for a redox flow battery, wherein the electrolyte liquid consists of a mixture of negative and positive electrolyte liquid of the redox flow battery, preferably in a ratio of 50:50, and the electrolyte liquid is circulated from a first tank through negative half-cells of one or more cell stacks of a purifying redox flow battery, whereby the electrolyte liquid passes through the negative half-cells, wherein a voltage is applied to the one or more cell stacks of the purifying redox flow battery and the electrolyte liquid in the negative half-cells is electrochemically reduced in the process, and that at least some of the contaminants in the electrolyte liquid are deposited on negative electrodes of the negative half-cells, wherein the electrolyte liquid, after passing through all the negative half-cells of the one or more cell stacks, passes through positive half-cells of the one or more cell stacks of the purifying redox flow battery via a connecting device which connects the negative half-cells and the positive half-cells of a cell stack to one another, without passing through a second tank. The technical effect that results from this is that the electrolyte liquid can be freed of contaminants after passing once through the negative half-cells of one or more cell stacks and the positive half-cells of one or more cell stacks. With this “single-pass method,” a purifying method for purifying electrolyte liquid can be carried out faster and more energy-efficiently. The effect of the deposition of contaminants in the electrolyte liquid on negative electrodes of the negative half-cells is thermodynamically determined and is usually unwanted during normal operation of a redox flow battery, since the contaminants that settle on the generally porous negative electrodes clog existing pores and also serve as hydrogen catalysts. Contaminants are substances that are unwanted in the electrolyte liquid and that may also impair the proper operation of a redox flow battery using the contaminated electrolyte liquid. According to the invention, however, this effect is used to purify an electrolyte liquid. Various suitable, electrochemically sufficiently stable, electrically conductive materials can be used as negative (and also positive) electrodes; often, mats made of carbon or graphite fibers are used. The positive electrodes serve to oxidize the electrolyte liquid and should be therefore composed of a material with low overpotential, which allows for a more efficient electrochemical reaction and thus faster deposition of the contaminants on the negative electrodes, since the low overpotential allows higher electrical currents to be applied to the cells of the purifying redox flow battery. Thus, during the purification process, the contaminants are deposited from the electrolyte liquid onto the negative electrodes of the negative half-cell of the purifying redox flow battery, thereby removing the contaminants from the electrolyte liquid. The electrolyte liquid purified in this way can then be used for proper operation of a redox flow battery.

To carry out the method according to the invention, a conventional redox flow battery can be used as the purifying redox flow battery. A commonly used voltage that is otherwise applied to the cell stack to charge the redox flow battery—usually 1.0-1.6 V per cell in the respective cell stack—can also be used, but instead of circulating separate negative and positive electrolyte liquids through the half-cells, a mixture of negative and positive electrolyte liquid is circulated through the negative half-cells as the electrolyte liquid to be purified. The negative and positive electrolyte liquid (usually present individually before mixing) should be largely uncharged, since otherwise no charging process can be “simulated” efficiently during the purification process and, in addition, an unwanted thermal reaction occurs when charged negative and positive electrolyte liquids are mixed to form an electrolyte liquid to be purified. To measure the proportion of contaminants currently present in the electrolyte liquid, known methods such as inductively coupled plasma mass spectrometry (ICP-MS) can be used, wherein the proportion of contaminants in the electrolyte liquid can be measured in the tanks or at any other point in the cycle of the purifying redox flow battery.

Moreover, a heat exchanger can be provided in the first tank and/or in the second tank, serving to dissipate thermal energy generated during the purification process.

After the contaminants in the electrolyte liquid have been reduced to the desired level, the electrolyte liquid can be oxidized and thus raised to the desired redox potential to produce a positive electrolyte liquid. This can be done, for example, by dilution with water or sulfuric acid. In order to produce a negative electrolyte liquid from the purified electrolyte liquid, the purified electrolyte liquid can be chemically or electrochemically reduced. Methods for oxidizing and reducing electrolyte liquids are well known and are therefore not described in greater detail herein.

In order to prevent hydrogen production caused by the contaminants deposited on the negative electrodes and to prevent recontamination of the electrolyte liquid by the contaminants dissolving from the negative electrodes, the negative electrodes of the negative half-cells of the purifying redox flow battery can be subjected to cleansing during or after the purification process in order to remove the coated contaminants. This can be done after the electrolyte liquid has been purified or during an interruption of the purification process. This cleansing of the negative electrodes can be carried out chemically, e.g., using an oxidizing agent such as positively charged electrolyte liquid, hydrogen peroxide H₂O₂, or electrochemically. The purifying redox flow battery must be in idle mode. If a positively charged electrolyte liquid is used to purify the negative electrodes, the preferably pure positive electrolyte liquid absorbs the contaminants. This can only be done until the positive electrolyte liquid has a certain level of contamination, at which point the positive electrolyte liquid can be subjected to a cleansing or disposed of.

The purifying method described primarily removes metallic contaminants by depositing them on the negative electrodes. The purifying method can be carried out until the proportion of contaminants in the electrolyte liquid reaches or falls below one or more of the following limit values: 0.5 mass ppm Cu; 1 mass ppm As, Pb, Sb; 0.1 mass ppm Rh, Ru, Au, Ag and other elements of the Pt group. A side effect of applying this method is that other substances, such as Sn, Pb, Bi, which, however, do not impair the proper operation of a redox flow battery when using the electrolyte liquid of a redox flow battery, are also deposited on the negative electrodes and are thus removed from the electrolyte liquid.

However, the proportion of sulfur dioxide SO₂ in the electrolyte liquid is also reduced; not by deposition on the negative electrodes, but by oxidation or reduction. Sulfur dioxide SO₂ also leads to increased hydrogen formation in a vanadium electrolyte liquid during operation, which is why the reduction of sulfur dioxide SO₂ has a beneficial effect.

The purifying method can be applied in particular to a vanadium electrolyte liquid. The vanadium electrolyte liquid is thus formed by the electrochemical reduction of the electrolyte liquid in the negative half-cells as bivalent vanadium V^{II}, which serves as an indicator of a successfully initiated purification process. An active purification process can be assumed starting at proportions of 0.001 M V^{II} and greater.

Other electrolyte liquids, such as iron-chromium electrolyte liquids (thus suitable for an iron-chromium redox flow battery) can also be purified in the manner described. It is important that the positive and negative electrolyte liquid are miscible, i.e., are chemically largely similar or only have a different oxidation state (e.g., V²⁺ and V³⁺, VO²⁺ and VO₂⁺ in case of vanadium redox flow batteries).

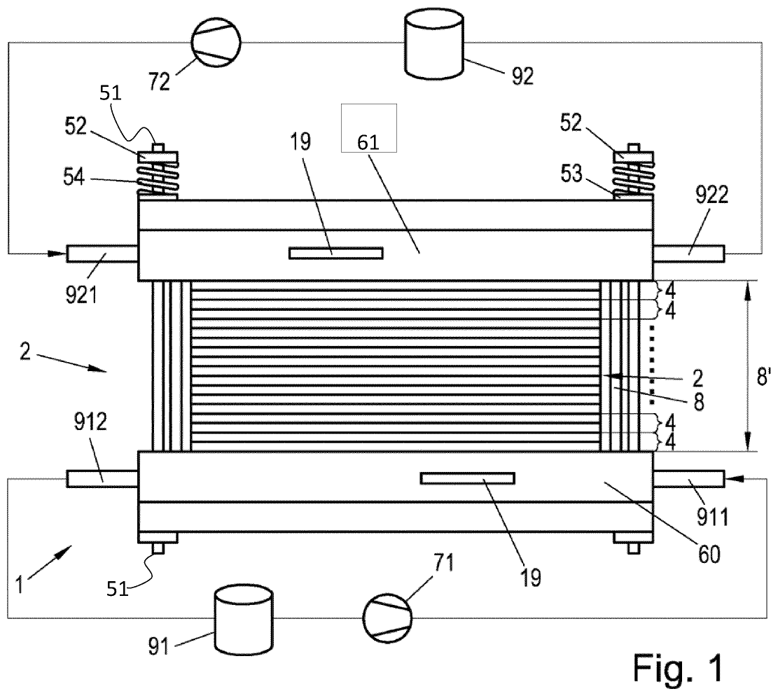

The present invention is described in greater detail below with reference to FIGS. 1 to 4, which show schematic and non-limiting advantageous embodiments of the invention by way of example. In the figures:

FIG. 1 shows a redox flow battery with a cell stack,

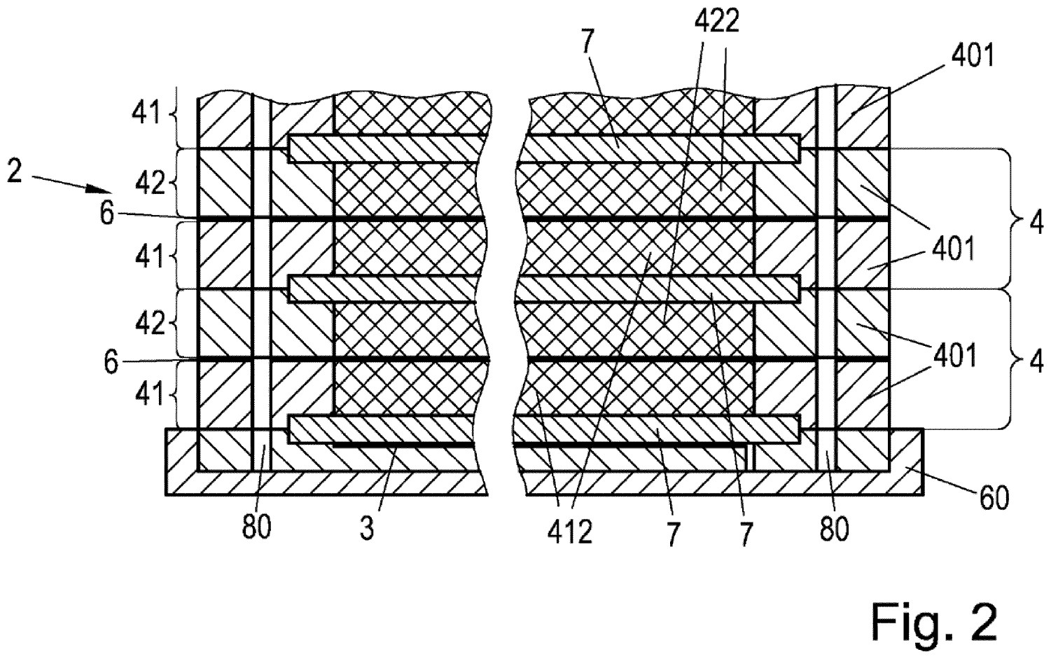

FIG. 2 shows a section of the cell stack,

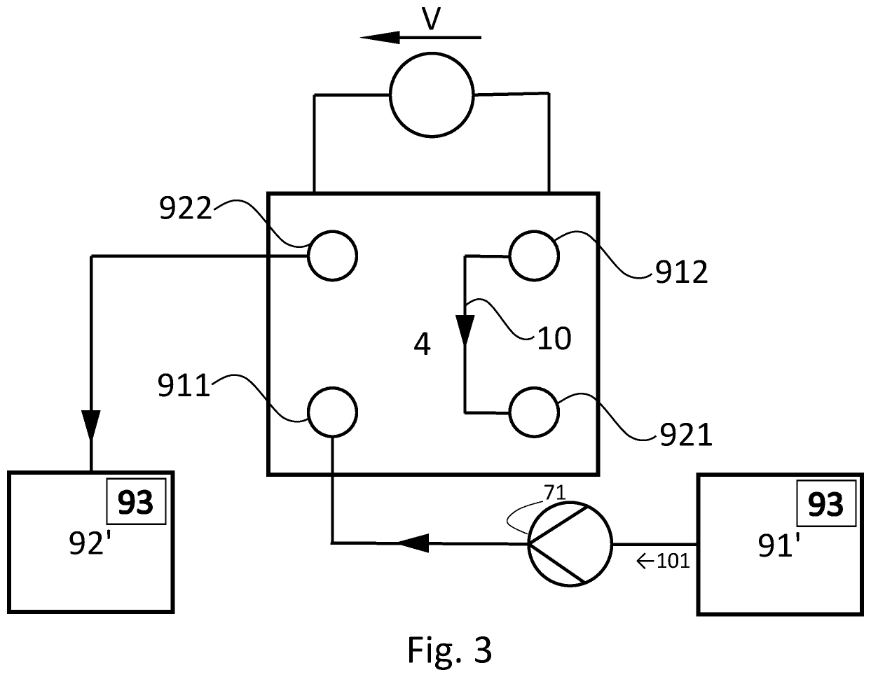

FIG. 3 shows a first embodiment of the purifying method,

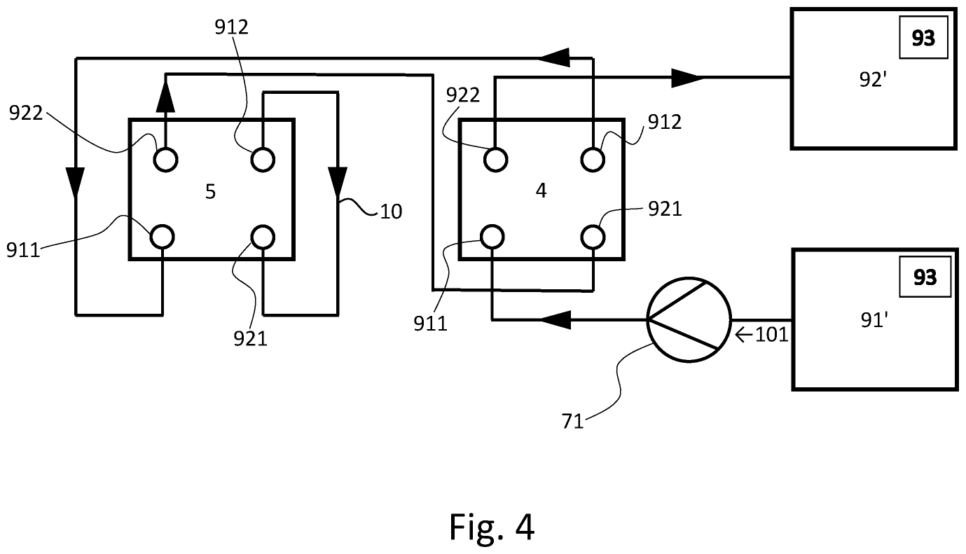

FIG. 4 shows a second embodiment of the purifying method.

With reference to FIGS. 1 and 2, the known construction of a common redox flow battery 1 according to the prior art will be explained. A cell stack 2 of a redox flow battery 1 comprises a plurality of cells 4. Each cell is formed from a positive half-cell 42 and a negative half-cell 41, i.e., positive half-cells 42 and negative half-cells 41 are arranged alternately in the cell stack 2. A semipermeable membrane 6, typically an ion exchange membrane (cation and/or anion exchange membrane, e.g., Nafion®) is arranged in each case between the positive half-cell 42 and the negative half-cell 41 of a cell 4. An electrode plate 7, for example a bipolar plate, is arranged between two adjacent cells 4. A positive electrode 422 is arranged in the frames 401 of the positive half-cells 42, and negative electrodes 412 are arranged in each of the frames 401 of the negative half-cells 41. The positive electrodes 422 and negative electrodes 412 are usually designed as mats made of carbon or graphite fibers. Via recesses 80 in the frames 401 of the positive half-cells 41 and negative half-cells 42, or cells 4, electrolytically differentially charged electrolyte fluids are pumped during normal operation through the cells 4 by means of the pumps 71, 72, wherein the positive electrode 422 in a cell 4 or the respective positive half-cell 42 is perfused by the positive electrolyte fluid, and the negative electrode 412 of the negative half-cell 41 is perfused by the negative electrolyte fluid. In some types of redox flow batteries 1, such as a vanadium redox flow battery or a vanadium polyhalite battery, the two electrolyte liquids are chemically largely similar or have only a different oxidation state in the half-cells (e.g., V²⁺ and V³⁺, VO²⁺ and VO₂⁺).

FIG. 1 also shows the tanks 91, 92 of a redox flow battery 1, in which the electrolyte fluids for operation are usually stored. In normal operation, i.e., in the course of power generation or storage, the electrolyte liquids are circulated between the negative half-cells 41 or positive half-cells 42 and the negative or positive tanks 91, 92 using the pumps 71, 72. The negative or positive tanks 91, 92 may be spatially separate containers, but may also be formed, for example, as two compartments separated by a partition in a common container. The cell stack 2 is completed at the two axial ends by a negative end plate 60 and a positive end plate 61, made, for example, of plastic. The negative end plate 60 and the positive end plate 61 are clamped by clamping means 50 consisting of passing bolts 51, nuts 52, washers 53 and springs 54, and thus compress the frames 401 of the negative half-cells 41 and positive half-cells 42 of the cell stack 2 together. An electrical connection 19 can be provided on each of the negative end plate 60 and positive end plate 61, via which the current collectors 3 in the interior of the redox flow battery 1 can be connected to an external circuit on both sides of the redox flow battery 1. For reasons of clarity, the electrical connection 19 is shown only in FIG. 1, and the connection between the current collector 3 and the electrical connection 19 cannot be seen in the Figures. Furthermore, the electrolyte fluid connections are provided for the supply and discharge of the electrolyte fluids in the exemplary embodiment at the end plates 60. A positive inflow 921 serves to supply the positive half-cells with electrolyte liquid (i.e., positive electrolyte liquid in normal operation), and a positive outflow 922 serves to return the electrolyte liquid to the positive tank 92 after passing the positive half-cells 42. Similarly, a negative inflow 911 serves to supply the negative half-cells 41 with electrolyte liquid (i.e., negative electrolyte liquid in normal operation), and a negative outflow 912 serves to return the electrolyte liquid to the negative tank 91 after passing the negative half-cells 41. In order to prevent a possible setting of the, for example elastic frames of the cells 4 by the contact pressure, spacers 8 may be provided between the negative end plate 60 and positive end plate 61 in order to ensure a constant distance 8′ between the negative end plate 60 and positive end plate 61.

For operation of the redox flow battery 1, it is desirable to keep the contaminants in the electrolyte liquid to be purified low, preferably below 1 ppm by weight. Contaminants can be As, Pb, Sb, Rh, Ru, Au, Ag, etc. The purifying method according to the invention can be carried out until the electrolyte liquid 101 has less than 0.5 mass ppm Cu and/or less than 1 mass ppm As, Pb, Sb and/or less than 0.1 mass ppm Rh, Ru, Au, Ag and/or other elements of the platinum group as contaminant 11. Preferably, the purifying method according to the invention can be carried out until the electrolyte liquid 101 has less than 0.1 mass ppm Cu and/or less than 0.1 mass ppm As, Pb, Sb and/or less than 0.01 mass ppm Rh, Ru, Au, Ag and/or other elements of the platinum group as contaminant 11. According to the invention, the electrolyte liquid is purified as follows.

For example, a vanadium electrolyte liquid is used as the electrolyte liquid 101 to be purified. The electrolyte liquid 101 has a V^{III}:V^{IV} ratio of about 50:50, as is also produced, for example, by mixing positive and negative electrolyte liquid of a vanadium redox flow battery as shown in FIG. 1 or can be produced by the methods known in the prior art. This means that there is a certain level of contaminants 11 in the electrolyte fluid 101, which must be reduced. A redox flow battery 1 as described in FIGS. 1 and 2 can be used as the purifying redox flow battery 1′ for applying the purifying method according to the invention, wherein a voltage V of e.g., 1.6 V per cell, which is normally used for charging, can be applied.

In the method according to FIG. 3, the electrolyte liquid 101 to be purified is stored in a first tank 91′. The first tank 91′ can be the tank of a purifying redox flow battery 1′, i.e., of a commercially available redox flow battery 1, as shown in FIG. 1. The purifying redox flow battery 1′ can be connected to a second tank 92′. The electrolyte liquid stored in the first tank 91′ can be circulated via the purifying redox flow battery 1′ through corresponding connections, as described below. If the purifying redox flow battery 1′ is used to purify electrolyte liquid, no positive and negative electrolyte liquid are circulated individually, but the electrolyte liquid to be purified consists of a mixture of positive and negative electrolyte liquid.

To reduce contaminants 11 in the electrolyte liquid 101 to be purified, the electrolyte liquid 101 is circulated through the purifying redox flow battery 1′. During this process, the electrolyte liquid 101 to be purified is circulated from a first tank 91′ through negative half-cells 41 of one or more cell stacks 4 of the purifying redox flow battery 1′, whereby the electrolyte liquid 101 passes through the negative half-cells 41. A voltage is applied to the one or more cell stacks 4 of the purifying redox flow battery (1′), and the electrolyte liquid 101 in the negative half-cells 41 is electrochemically reduced. At least some of the contaminants 11 in the electrolyte liquid 101 are deposited on negative electrodes 410 of the negative half-cells 41. After passing through the negative half-cells 41 of the one or more cell stacks 4 of the purifying redox flow battery 1′, the electrolyte liquid 101 to be purified passes through the positive half-cells 42 of the one or more cell stacks 4 of the purifying redox flow battery 1′ without passing through a second tank. This essentially means that the electrolyte liquid exiting the negative half-cells 41 is fed directly into the positive half-cells 42. For this purpose, a connecting device 10 is provided, which connects the negative half-cells 41 and the positive half-cells 42 of the one or more cell stacks 4 to one another. The connecting device 10 can be integrated in the purifying redox flow battery 1′, for example in the frame 401 of the half-cells 41, 42, but can also be arranged externally on the purifying redox flow battery 1′.

In the negative half-cell 41, V^{IV} is electrochemically reduced to V^{III} in the electrolyte liquid 101, wherein some of the V^{III} is subsequently electrochemically reduced to V^{II}. A concentration of more than 0.001 M of V^{II} is achieved in the negative half-cell 41, which is an indicator of the ambiance required for purification. Thus, the, usually metallic, contaminants 11 are electrochemically or chemically coated onto the negative electrodes 412 of the negative half-cells 41 of the purifying redox flow battery 1′, e.g., as part of the 2 V²⁺+Cu²⁺↔2 V³⁺+Cu reaction. For example, Cu²⁺+2e⁻→Cu can take place as a purely electrochemical reaction, wherein this electrochemical reaction takes place in parallel with the usual redox reaction V³⁺+e⁻→V²⁺.

According to a preferred embodiment of the invention shown in FIG. 3, the electrolyte liquid 101 to be purified is circulated through the negative half-cells 41 of the purifying redox flow battery 1′ via the negative inflow 911 and the negative outflow 912 and then, without first passing through a second tank, is circulated through the positive half-cells 42 of the purifying redox flow battery 1′ via the positive inflow 921 and the positive outflow 922, and is particularly preferably stored in a second tank 92′, which can very particularly preferably be the tank of a purifying redox flow battery 1′. In this embodiment, the connecting device 10 is a conduit connecting the negative outflow 912 and the positive inflow 921 to one another.

The electrolyte liquid 101 is pumped from a first tank 91′ via the negative inflow 911 through the negative half-cells 41 of the cell stack 4 of the purifying redox flow battery 1′. The electrolyte liquid 101 is further pumped from the negative half-cells 41 via the negative outflow 912 and via a connecting device 10, without passing through a second tank 92′, and via the positive inflow 921 through the positive half-cells 42 of the cell stack 4 of the purifying redox flow battery 1′. The electrolyte liquid 101 is further pumped from the positive half-cells 42 of the first cell stack 4 via the positive outflow 922 into a second tank 92′.

The connecting device 10 can be designed as any type of conduit for guiding the electrolyte liquid. The connecting device 10 can preferably be designed as a hose, wherein the hose can particularly preferably be made of rubber, plastic, elastomer or synthetic raw materials. Furthermore, the connecting device can also be designed as a hose, which can be made from a renewable raw material, such as rubber. The connecting device 10 can preferably be connected to the cell stacks by means of nozzles or hose nozzles.

The negative half-cells 41 are connected to the negative inflow 911 and the negative outflow 912, wherein the electrolyte liquid 101 can enter the negative half-cells 41 via the negative inflow 911 and can flow out of the negative half-cells 41 via the negative outflow 912. The positive half-cells 42 are connected to the positive inflow 921 and the positive outflow 922, wherein the electrolyte liquid 101 can enter the positive half-cells 42 via the positive inflow 921 and can flow out of the positive half-cells 42 via the positive outflow 922.

The electrolyte to be purified can heat up due to the purification process. Such heating of the electrolyte is not wanted, wherein a temperature of the electrolyte liquid should not exceed 40° C. during the purification process. Therefore, a heat exchanger 93 for dissipating thermal energy can be provided in the first tank 91′ and/or in the second tank 92′, as shown in the exemplary embodiment according to FIG. 3a. This means that the target maximum temperature of 40° C. is not reached in case of an assumed basic operating temperature of 30° C.

The formation of hydrogen in the electrolyte liquid 101, i.e., in the negative half-cell 41, caused by contaminants 11 can also result in more vanadium with oxidation number +4 being formed in the positive half-cell 42 than the electrolyte liquid 101 originally had before it was pumped into the negative half-cell 41. This would therefore result in an imbalance in the state of charge of the electrolyte liquid 101 and the oxidation number of the electrolyte liquid 101 would shift from an initial +3.50 towards +4, wherein the extent of this effect depends on the duration of the application of the purifying method and the initial concentration of the contaminants 11 in the electrolyte liquid 101. Hydrogen production is primarily dependent on how long the negative electrode 412 coated with the contaminants 11 is in contact with the electrolyte liquid 101. In principle, therefore, an even faster reduction of the contaminants 11 is desirable.

FIG. 4 shows a second preferred embodiment of the purifying method according to the invention.

The electrolyte liquid 101 is pumped from a first tank 91′ via the negative inflow 911 of the first cell stack 4 through the negative half-cells 41 of the second cell stack 4 of the purifying redox flow battery 1′. The electrolyte liquid 101 is further pumped from the negative half-cells 41 of the first cell stack 4 via the negative outflow 912 of the first cell stack 4 and via the negative inflow 911 of the second cell stack 5 through the negative half-cells 41 of the second cell stack 5 of the purifying redox flow battery 1′. The electrolyte liquid 101 is further pumped from the negative half-cells 41 of the second cell stack 5 via the negative outflow 912 of the second cell stack 5 via a connecting device 10, without passing through a second tank 92′, and via the positive inflow 921 of the second cell stack 5 through the positive half-cells 42 of the second cell stack 5 of the purifying redox flow battery 1′. The electrolyte liquid 101 is further pumped from the positive half-cells 42 of the second cell stack 5 via the positive outflow 922 of the second cell stack 5 and via the positive inflow 921 of the first cell stack 4 through the positive half-cells 42 of the first cell stack 4 of the purifying redox flow battery 1′. The electrolyte liquid 101 is further pumped from the positive half-cells 42 of the first cell stack 4 via the positive outflow 922 of the first cell stack 4 into a second tank 92′. A heat exchanger 93 for dissipating thermal energy can be provided in the first tank 91′ and/or in the second tank 92′ also according to the preferred embodiment shown in FIGS. 4a and 4b, in order not to reach the desired maximum temperature of 40° C. at an assumed basic operating temperature of 30° C.

Moreover, during or after the purification process, the negative electrodes 410 of the negative half-cells 41 of the purifying redox flow battery 1′ may be subjected to a cleansing in order to remove the contaminants 11 deposited on the negative electrodes 410.

1. A purifying method for reducing contaminants in a vanadium electrolyte liquid suitable for a redox flow battery, the vanadium electrolyte liquid comprising:
a mixture of negative and positive vanadium electrolyte liquid of the redox flow battery in a ratio of 50:50, and the vanadium electrolyte liquid being circulated from a first tank through negative half-cells of one or more cell stacks of a purifying redox flow battery, by which the vanadium electrolyte liquid passes through the negative half-cells, wherein a voltage is applied to the one or more cell stacks of the purifying redox flow battery and the vanadium electrolyte liquid in the negative half-cells is electrochemically reduced in the process, wherein at least some of the contaminants in the vanadium electrolyte liquid are deposited on negative electrodes of the negative half-cells, wherein the vanadium electrolyte liquid, after passing through the negative half-cells of the one or more cell stacks, passes through positive half-cells of the one or more cell stacks of the purifying redox flow battery, without passing through a second tank, via a connecting device that connects the negative half-cells and the positive half-cells of a cell stack, and wherein the vanadium electrolyte liquid is fed to a second tank after passing through positive half-cells of the one or more cell stacks and is stored in the second tank.

2. The purifying method according to claim 1, wherein the negative half-cells are connected to a negative inflow and a negative outflow, wherein the vanadium electrolyte liquid is fed into the negative half-cells via the negative inflow and is guided out of the negative half-cells via the negative outflow, and the positive half-cells are connected to a positive inflow and a positive outflow, wherein the electrolyte liquid is fed into the positive half-cells via the positive inflow and is guided out of the positive half-cells via the positive outflow, wherein the connecting device connects the negative outflow and the positive inflow to one another.

3. A purifying method for reducing contaminants in a vanadium electrolyte liquid suitable for a redox flow battery, the vanadium electrolyte liquid comprising:
a mixture of negative and positive vanadium electrolyte liquid of the redox flow battery in a ratio of 50:50, and the vanadium electrolyte liquid being circulated from a first tank through negative half-cells of a first cell stack of a purifying redox flow battery, whereby the vanadium electrolyte liquid passes through the negative half-cells of the first cell stack, wherein the negative half-cells of the first cell stack are connected to negative half-cells of a second cell stack, by which the vanadium electrolyte liquid passes through the negative half-cells of the second cell stack, wherein a voltage is applied to the first cell stack and the second cell stack of the purifying redox flow battery and the vanadium electrolyte liquid in the negative half-cells of the first cell stack and of the second cell stack is electrochemically reduced in the process, and in that at least some of the contaminants in the vanadium electrolyte liquid are deposited on negative electrodes of the negative half-cells of the first cell stack and of the second cell stack, wherein the vanadium electrolyte liquid, after passing through the negative half-cells of the first cell stack and of the second cell stack, passes through the positive half-cells of the second cell stack of the purifying redox flow battery via a connecting device which connects the negative half-cells of the second cell stack and the positive half-cells of the second cell stack to one another without passing through a second tank.

4. The purifying method according to claim 3, wherein the positive half-cells of the second cell stack are connected to positive half-cells of the first cell stack, whereby the vanadium electrolyte liquid passes through the positive half-cells of the first cell stack.

5. The purifying method according to claim 3, wherein the vanadium electrolyte liquid is fed to a second tank after passing through the positive half-cells of the first cell stack.

6. The purifying method according to claim 1, wherein the connecting device is preferably designed as one or more hoses.

7. The purifying method according to claim 1, wherein the connecting device does not exceed a length of 100 meters.

8. The purifying method according to claim 1, wherein the vanadium electrolyte liquid is oxidized after completion of the purification process.

9. The purifying method according to claim 1, wherein during or after the purification process, the negative electrodes of the negative half-cells are subjected to a cleansing in order to remove the contaminants deposited on the negative electrodes.

10. The purifying method according to claim 1, wherein the purifying method is carried out until the vanadium electrolyte liquid has less than 0.5 mass ppm Cu as contaminant.

11. The purifying method according to claim 1, wherein the purifying method is carried out until the vanadium electrolyte liquid has less than 1 mass ppm As, Pb, Sb as contaminants.

12. The purifying method according to claim 1, wherein the purifying method is carried out until the vanadium electrolyte liquid has less than 0.1 mass ppm of each of the following elements: Rh, Ru, Au, Ag and other elements of the Pt group.

13. The purifying method according to claim 1, wherein the electrochemical reduction of the electrolyte liquid in the negative half-cells is formed by divalent vanadium.
